(19) United States
(12) Patent Application Publication
(10) Pub. No.: US 2007/0276080 A1
(43) Pub. Date: Nov. 29, 2007

(54) Melt fabrication of fiber-filled fluoropolymer

(76) Inventor: Jacob Lahijani, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/803,656

(22) Filed: May 15, 2007

Related U.S. Application Data
(60) Provisional application No. 60/808,437, filed on May 25, 2006.
(60) Provisional application No. 60/839,143, filed on Aug. 21, 2006.

(51) Int. Cl. C08K 3/40; C08K 3/04

(52) U.S. Cl. 524/494; 524/495

(57) ABSTRACT

A molding process is provided for a composition comprising fiber, such as glass, aramid, PTFE fiber, or carbon fiber, and melt-fabricable fluoropolymer, wherein the decrease in melt flowability of the composition as arises when the composition is provided to the process as conventional size melt-formed pellets is minimized by providing the composition to the process in the form melt-formed particles, at least 80 wt % of these particles having a width no greater than about 70 mils (1784 micrometers).

### FIELD OF THE INVENTION

This invention relates to the melt fabrication of melt-fabricable fluoropolymer containing a high proportion of fiber.

### BACKGROUND OF THE INVENTION

Glass fiber is added to melt-fabricable fluoropolymer to increase the rigidity (modulus) of articles molded from the resulting composition, typically by such processes as extrusion, injection molding, and compression molding. In molding, mechanical pressure is applied to cause the molten composition to flow sufficiently to form the desired shape of the article. It has been customary to feed the composition to these processes as melt-formed pellets, typically formed by melt extrusion of the composition into a strand and chopping up the strand, wherein the resulting pellets are about 3000 to 4000 micrometers (118 to 157 mils) in diameter and about 2000 to 3500 micrometers (80 to 140 mils) in length. As the glass fiber content of the composition increases to increase the rigidity and dimensional stability of the molded article, e.g. at least 15 wt %, often at least 30 wt % glass fibers, both based on the combined weight of the glass fibers and melt-fabricable fluoropolymer, the melt flow of the composition decreases, making it difficult to extrude the composition as a strand. Canadian Patent 900075 discloses for ethylene/tetrafluoroethylene copolymer (ETFE), that the melt viscosity increases from 1.8×10⁴ poises (no glass fiber filler) to 6.49×10⁴ poises (26 wt % glass fiber filler). This difficulty carries over into the molding process, which manifests itself as an incomplete filling of the mold in the case of injection molding, longer cycle time for compression molding to avoid porosity in the molded article, and slow extrusion rate.

### SUMMARY OF THE INVENTION

The present invention overcomes this difficulty by the process comprising molding a molten composition comprising glass fiber and melt-fabricable fluoropolymer to form an article, said molten composition being obtained by melting melt-formed particles of said composition, said particles having a width of no greater than about 70 mils (1784 micrometers). This process of incorporating glass fiber into such small fluoropolymer particles is also applicable to other fibers having a melting temperature above that of the fluoropolymer and above the melting temperature used to carry out the incorporation. The fibers used in the present invention can be inorganic, such as glass fibers, or organic, such as polymer fibers, such as aramid fiber and PTFE (polytetrafluoroethylene) fiber. Carbon fiber can also be used; this is considered an organic fiber because of its usual derivation from hydrocarbon polymers. The use of these fibers other than glass fiber provides advantage similar to when glass fiber is used in the molding process.

Surprisingly the small highly fiber-filled particles of the present invention, which resemble coarse sand particles, especially as the width of the particles are made even smaller, can be formed by melt-extrusion through a very small diameter extrusion orifice. This is surprising because the fibers do not plug up the small diameter extrusion orifice necessary to produce the small-width particles, as would be expected with the large amount of fibers present in the composition, e.g. at least 15 wt %, based on the combined weight of the fibers and melt-fabricable fluoropolymer or at least 10 vol % based on the combined volume of the fiber and fluoropolymer. All of the wt %s and vol %s disclosed hereinafter are on this same basis unless otherwise indicated. Indeed, observation of the extrusion orifice producing these small particles reveals that the orifice is quite small, leading to the expectation that the fibers would plug the extrusion orifice. A special extrusion die design is provided that avoids this result, as will be explained hereinafter.

The improvement arising from having these very small fiber-filled particles as the feed to the process of molding a molten composition comprising fiber and melt-fabricable fluoropolymer to form said composition into an article is to minimize the decrease in melt flow that otherwise occurs when the larger fiber-filled pellets of the composition are used. This effect on melt flowability is with respect to the melt-fabricable fluoropolymer by itself subjected to the same molding conditions. The improvement obtained by the present invention manifests itself in the molding result, complete filling of the mold in the injection molding process, faster extrusion rate, faster cycle time in compression molding to produce articles free of porosity. The molding processes of the present invention all involve the application of mechanical pressure to the molten composition to form it into the article shape desired. In injection molding, this mechanical pressure is applied by a screw pump, in compression molding, by a ram, and in extrusion, by an extrusion screw. This application of mechanical pressure to the molten composition formed from the particles described above causes the more fluid composition of the invention to give the improved molding result. The contribution to injection molding is especially noteworthy, because it enables the molding of articles that would otherwise not be melt fabricable by injection molding by virtue of the mold cavity not filling completely with the fluoropolymer/glass fiber composition. The conventional size of the pellets in Canadian Patent 900075, i.e. 3200 micrometers in diameter×3200 micrometers in length, sometimes called molding granules and molding powder therein, leads to the melt-fabrication of ETFE/glass fiber composition only by compression molding in the Examples.

Another embodiment of the present invention is the small fiber-filled particles themselves, which are preferably melt-formed particles of composition comprising fibers and melt-fabricable fluoropolymer, said fibers constituting at least 15 wt % of the combined weight of said fibers and said melt-fabricable fluoropolymer, at least 80 wt % of said particles having a width no greater than about 70 mils (1784 micrometers) and length no greater than about 80 mils (2400 micrometers). Just as the TFE copolymer minicubes of U.S. Pat. No. 6,632,902 useful for rotomolding can have some variability in size (length and width), so do the fiber-filled particles of the present invention. The extrusion of TFE copolymer in '632 is disclosed to produce die swell, i.e. the minicube has a larger diameter than the diameter of the extrusion orifice (sentence bridging cols. 2 and 3). The effect of the fiber in the composition melt-formed by extrusion of the composition as a strand in the present invention, followed by chopping up the strand into particles, essentially prevents die swell, and results in particles having a smaller width, e.g. diameter, than that of the extrusion orifice. By way of example, an extrusion orifice of 64 mils (1631 micrometers) typically produces smaller diameter glass-filled/melt-fabricable fluoropolymer particles, e.g. as small as 45 mil (1147 micrometers). This reduction in diameter of the particles from the diameter of the extrusion orifice is surprising because the presence of the fibers in the extruded strand reduces the melt strength of the molten extrudate. The melt-formed particles of the present invention exhibit surprising increase in melt flowability as compared to the same composition provided in the conventional pellet sizes disclosed above. It is unexpected that better mold filling, and thereby improved injection moldability, arises from decreasing the particle size of the fluoropolymer/fiber composition from the 3000 to 4000 micrometer diameter/1000 to 2000 micrometer length pellet sizes.

### DESCRIPTION OF THE DRAWINGS

FIG. 1 is a photograph of a side view of a fiber-filled/melt-fabricable fluoropolymer particle of the present invention magnified 100×.

FIG. 2 is a photograph of an end view of a fiber-filled/melt-fabricable fluoropolymer particle of the present invention, magnified 100×.

FIG. 3 is a schematic side cross-sectional view of a typical extrusion die for extruding a strand of fiber-filled/melt-fabricable fluoropolymer strand for cutting into pellets.

FIG. 4 is a schematic side cross-sectional view of one embodiment of extrusion die used in the present invention.

### DETAILED DESCRIPTION OF THE PREFERRED EMBODIMENTS

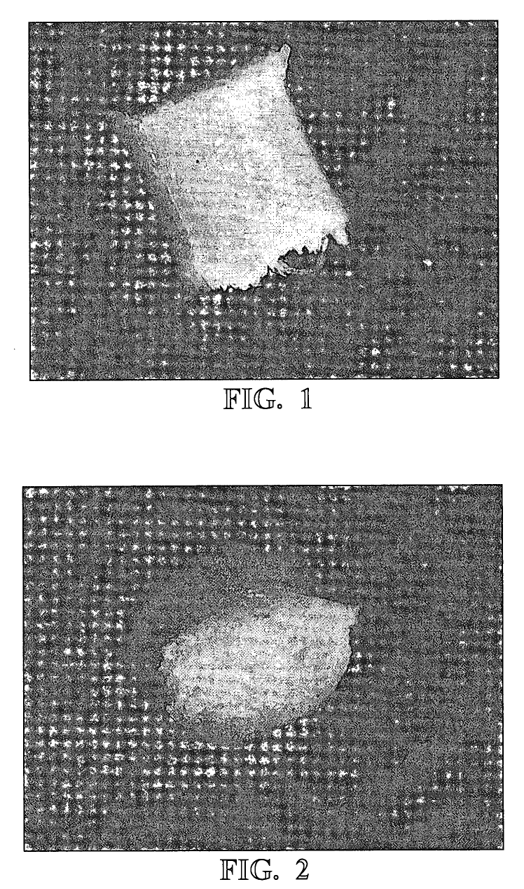

The photographic views of FIGS. 1 and 2 of the fiber-filled/melt-fabricable fluoropolymer particle of the present invention shows it to be approximately cylindrical in shape, with this particular particle having an oval cross-sectional shape even though extruded from an extrusion orifice of circular shape. This oval shape arises from the method of conveying the extruded strand to the cutter that chops the strand into particles. The extruded strand is allowed to droop into an elongated water bath, which quenches and thereby solidifies the strand. The cooled strand is pulled through the water bath and into the cutter by an intervening pair of rotating opposing nip rolls.

It is apparent from the photographic views of FIGS. 1 and 2 that the fibers occupy a considerable portion of the cross-section of the particle. In these Figs. the fibers are glass fibers. Numerous strand ends are seen projecting from the surface (cut end) of the particle in FIG. 1 and these fibers are visible in FIG. 2 as light-colored portions as compared to the darker-colored fluoropolymer portions enveloping the glass fibers. The fluoropolymer in this particle is ethylene/tetrafluoroethylene copolymer, and the amount of glass fiber in the particle is 30 wt %. As is apparent from FIG. 2, the particle is quite “stuffed” with glass fiber.

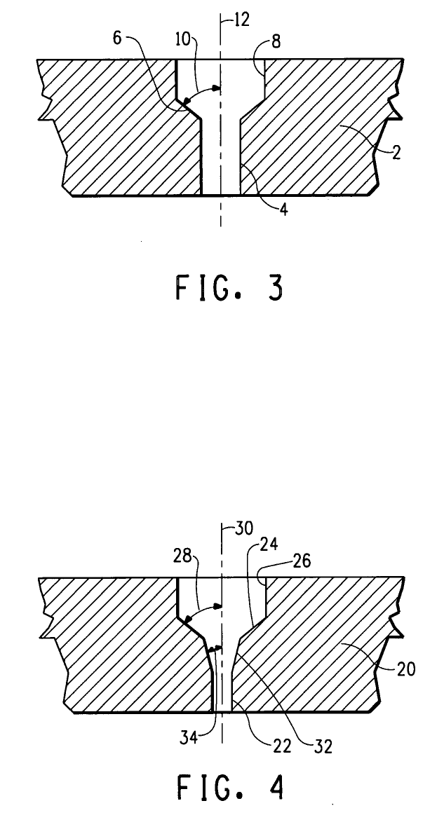

FIG. 3 shows a conventional extrusion die 2 for extruding a strand of melt-fabricable fluoropolymer, with or without fiber. In this die, the extrusion orifice 4 is preceded by an outwardly tapering conical portion 6 and next by a cylindrical feed portion 8 that communicates with the discharge end of an extruder (not shown). The conical portion 6 forms an angle 10 of 45° with the centerline 12 of the orifice 4. The conical portion 6 guides the molten polymer into the extrusion orifice for extrusion as a strand for cutting up into the large-size pellets (3000 to 4000 micrometers (118 to 157 mils) in diameter by 1000 to 2000 micrometers (39 to 78 mils) in length) described above. This die design has also been used to form the extruded strand for cutting up into the minicubes disclosed in U.S. Pat. No. 6,632,902.

While the die design of FIG. 3 has been useful for making the large size glass-filled pellets, i.e. the molten strand was continuously extrudable, it was not useful for making the melt-formed fiber-filled/melt-fabricable fluoropolymer particles of the present invention. The extruded strand, as expected, would plug with the fibers, causing intermittent rupture of the extruded strand.

FIG. 4 shows the extrusion die design that enabled a small diameter fiber-filled/melt-fabricable strand to be extruded that could be then cut up into the melt-formed particles of the present invention. In this design, the die 20 contains the small diameter extrusion orifice 22, conically tapered portion 24 and cylindrical feed portion 26. As in FIG. 3, the conically tapered portion 24 forms an angle 28 of 45° with the centerline 30 through the extrusion orifice 22. The difference from the die design of FIG. 3 is the provision of a smaller angle conically tapered portion 32 forming a transition between the conical portion 24 and the orifice 22. The conical portion 32 forms an angle 34 of 20° with the centerline 30. Instead of bridging the small diameter orifice with clumps of fibers to interrupt the flow of the molten strand, the conical portion 32 aligns the polymer molecules in the flow direction and this, in turn, guides the fibers lengthwise into the orifice so that they are aligned in one direction, the flow (extrusion) direction, and pass through the orifice, enveloped by the molten fluoropolymer. Thus, the strand of the fiber/melt-fabricable fluoropolymer composition is extruded, and the fibers in the composition align in the extrusion direction during this extrusion. It is contemplated that other low angles and/or additional conical tapers in portion 24 and/or portion 32 will provide this result.

The chopping up of the solidified strand obtained from the die design of FIG. 4 provides the particles of the present invention, wherein the fibers are aligned in one direction within the particle. This alignment is not necessary to either the functionality of the particle or its use in the process of the present invention, but is the result of the most convenient and economical way, extrusion, of obtaining the fiber-filled melt-fabricable fluoropolymer particles of, and used in, the present invention. When the particles are used in the subsequent molding process, the resultant melting process causes the small particles to flow together, forming a molten mass wherein the fibers extend in multiple directions.

Surprisingly, the resultant molten mass has good melt flowability, better than the molten mass obtained from the larger fiber-filled/melt-fabricable fluoropolymer pellets, and which facilitates the molding of articles by the application of pressure to this molten mass. This improvement manifests itself, i.e. is especially visible, in the injection molding of intricate articles, such as those containing a thin wall. For such articles, when the use of the large-size fiber-filled/melt-fabricable pellets results in incomplete filling of the mold, sometimes, or all the time, use of the small-size fiber-filled/melt-fabricable fluoropolymer particles according to the present invention, results in consistent filling of the mold.

Any glass fiber can be used in the present invention. Such glass fiber is high temperature resistant, such that it does not melt or soften to lose the fiber shape at the melt processing temperature for the particular fluoropolymer being used. A preferred glass from which the fiber if made is E-glass, which is a low alkali borosilicate glass. The denier of the glass fiber is fine enough that the cross-sectional area of all the fibers present in the particle is no greater than about 50% of the cross-sectional area of the extrusion orifice. Typically, the glass fiber will have a diameter of 5 to 50 micrometers, more preferably 5 to 20 micrometers. The invention is not limited to any particular finish (coupling agent) on the glass fiber. Generally, the glass fiber, with or without finish, is incompatible with the fluoropolymer, i.e. is not wet by the molten fluoropolymer. This is in contrast to hydrocarbon polymers, such as polyolefins and polyamides, that will adhere to glass fiber coated with a finish (coupling agent). Preferably, the glass fiber is free of coupling agent.

The thermal requirements for the glass fiber are the same for other inorganic fibers and for organic fibers, such as those of carbon (such as from Toray Carbon Fibers, Decatur Ala. USA), aramid (such as Kevlar® and Nomex®, available from DuPont, Wilmington Del. USA), and PTFE fiber (such as TFA Teflon® PTFE fibers available from Toray Fluorofibers (America), Decatur Ala. USA).

The fluoropolymers used in the present invention are preferably partially crystalline and are melt-fabricable, which means that they are sufficiently flowable in the molten state (heated above melting temperature) that they can be fabricated by such pressure applying molding processes such as extrusion, injection molding and compression molding. The melt flowability of the fluoropolymer can be described in terms of melt flow rate as measured in accordance with ASTM D-1238, and the fluoropolymers used in the present invention preferably have a melt flow rate (MFR) of at least 1 g/10 min, determined at the temperature which is standard for the particular fluoropolymer; see for example, ASTM D 2116a and ASTM D 3159-91a. Melt viscosity (MV) in poises is calculated from the measured MFR as follows: MV=53170/MFR in g/min, as disclosed in U.S. Pat. No. 4,380,618 (col. 3, I. 50-52). Thus, literature reported melt viscosities can be back-calculated to MFR. For example, the melt viscosities of 3.04×10⁴ poises and 4.3×10⁴ poises disclosed in Examples 2 and 3 of Canadian Patent 900075 correspond to MFRs of 17.5 and 12.4 g/10 min, respectively (calculation: MFR in g/10 min=531700/3.04×10⁴ poises). The method of measuring of MFR for fluoropolymers is unique to (especially for) fluoropolymers because of the high melt viscosity of fluoropolymers as compared to hydrocarbon-based polymers. Polytetrafluoroethylene (PTFE) is generally not melt processible, i.e. it does not flow at temperatures above its melting temperature, whereby this polymer is not melt-fabricable. Low molecular weight PTFE is available, called PTFE micropowder, the molecular weight being low enough that this polymer is flowable when molten, but because of the low molecular weight, the resultant molded article has no strength. The absence of strength is indicated by the brittleness of the article. If a film can be formed from the micropowder, it fractures upon flexing. In contrast, the melt-fabricable fluoropolymers used in the present invention can be formed into films that can be repeatedly flexed without fracture. This flexibility can be further characterized by an MIT flex life of at least 500 cycles, preferably at least 1000 cycles, and more preferably at least 2000 cycles, measured on 8 mil (0.2 mm) thick compression molded films that are quenched in cold water, using the standard MIT folding endurance tester described in ASTM D-2176F.

The preferred melt-fabricable fluoropolymers for use in the present invention comprise one or more repeat units selected from the group consisting of —CF₂—CF₂—, —CF₂—CF(CF₃)—, —CF₂—CH₂—, —CH₂—CHF— and —CH₂—CH₂—, these repeat units and combinations thereof being selected with the proviso that the fluoropolymer contains at least 35 wt % fluorine, preferably at least 50 wt % fluorine. Thus, although hydrocarbon units may be present in the carbon atom chain forming the polymer, there are sufficient fluorine-substituted carbon atoms in the polymer chain to provide the desired minimum amount of fluorine present, so that the fluoropolymer exhibits chemical inertness. The fluoropolymer preferably also has a melting temperature of at least 150° C., preferably at least 200° C., and more preferably at least 240° C.

Examples of perfluoropolymers, i.e., wherein the monovalent atoms bonded to carbon atoms are all fluorine, except for the possibility of other atoms being present in end groups of the polymer chain, include copolymers of tetrafluoroethylene (TFE) with one or more perfluoroolefins having 3 to 8 carbon atoms, preferably hexafluoropropylene (HFP). The TFE/HFP copolymer can contain additional copolymerized perfluoromonomer such as perfluoro(alkyl vinyl ether), wherein the alkyl group contains 1 to 5 carbon atoms. Preferred such alkyl groups are perfluoro(methyl vinyl ether), perfluoro(ethyl vinyl ether) and perfluoro(propyl vinyl ether). Typically, the HFP content of the copolymer is about 7 to 17 wt %, more typically 9 to 17 wt % (calculation: HFP Index (HFPI)×3.2) and the additional comonomer when present constitutes about 0.2 to 3 wt %, based on the total weight of the copolymer. The TFE/HFP copolymers with and without additional copolymerized monomer is commonly known as FEP.

Examples of hydrocarbon/fluorocarbon polymers (hereinafter “hydrofluoropolymers”) that can be used in the present invention include vinylidene fluoride polymers (homopolymers and copolymers), typically called PVDF, copolymers of ethylene (E) with TFE, typically containing 40 to 60 mol % of each monomer, to total 100 mol %, and preferably containing additional copolymerized monomer such as perfluoroalkyl ethylene, preferably perfluorobutyl ethylene. These copolymers are commonly called ETFE. While ETFE is primarily composed of ethylene and tetrafluoroethylene repeat units making up the polymer chain, it is typical that additional units or from a different fluorinated monomer will also be present to provide the melt, appearance, and/or physical properties, such as to avoid high temperature brittleness, desired for the copolymer. Examples of additional monomers include perfluoroalkyl ethylene, such as perfluorobutyl ethylene, perfluoro(ethyl or propyl vinyl ether), hexafluoroisobutylene, and CH₂═CFR_{f} wherein R_{f} is C₂-C₁₀ fluoroalkyl, such as CH₂═CFC₅F₁₀H, hexafluoropropylene, and vinylidene fluoride. Typically, the additional monomer will be present in 0.1 to 10 mol % based on the total moles of tetrafluoroethylene and ethylene. Such copolymers are further described in U.S. Pat. Nos. 3,624,250, 4,123,602, 4,513,129, and 4,677,175. Additional hydrofluoropolymers include EFEP and the copolymer of TFE, HFP and vinylidene fluoride, commonly called THV. Preferably the MFR of ETFE is no greater than about 10 g/10 min. Notwithstanding this low MFR, the molding process of the present invention and the small particle melt-formed particles used therein provide improved melt flowability as compared to the conventional glass fiber-filled ETFE pellets used heretofore.

The fluoropolymers used in the present invention are all characterized by a high melting temperature, e.g. at least about 175° C., usually at least about 200° C. and most often at least about 225° C. The molding of these fluoropolymers is carried out at considerably higher temperatures, usually greater than 300° C., and most often greater than about 325° C. Even at these extremely high temperatures, the fiber remains incompatible with the fluoropolymer, decreasing the melt flow of the molten mixture obtained prior to formation of the fiber-filled particles.

The melt-formed fiber-filled/melt-fabricable fluoropolymer particles of the present invention can contain other ingredients, such as pigments in an effective amount to color the particle and thus the article molded therefrom. The pigment carbon black can also be present for colorant purpose or for the purpose of rendering the particles and the articles molded therefrom sufficiently electrically conductive that the article dissipates static electrical charge.

The fiber-filled/melt-fabricable fluoropolymer particles used in the present invention can be made by dry mixing fibers chopped to the length desired, e.g. 100 to 300 mils (2550 to 7650 micrometers) with melt-formed pellets, e.g. measuring 125 mils (3185 micrometers) in diameter and 175 mils (4460 micrometers) in length and then melt mixing the resultant composition and extruding it through the die design such as shown in FIG. 4 to form a molten strand of the fibers enveloped in the fluoropolymer. Typically the chopping up (cutting) of the strand will be done on solidified strand, rather than molten strand, to avoid the formation of a “tail” on the particle. The strand is conveniently solidified by allowing it to droop downwardly under the influence of gravity into an elongated tray (bath) containing cold water. The strand enters the cold water at one end of the tray and passes through rotating nip rolls at the opposite end of the tray, the nip rolls pulling the quenching strand through the water in the tray. Usually a stream of air (an air knife) ahead of the nip rolls blows superficial water off the strand. It has been found that notwithstanding the high loading of the extruded strand with fibers, the nip rolls can operate at a faster rate than the rate of extrusion so as to result is some drawing of the extruded strand to produce a smaller diameter strand (and particle) than the diameter of the extrusion orifice. The nip rolls feed the cooled strand into a conventional cutter that then chops up the strand into the melt-formed particles used in the present invention. The melt-formation of the particles arises from the preceding melt mixing/extrusion process, and the particles result from the cutting step.

Preferably, the portions of fiber filling in the melt-fabricable fluoropolymer particles, when the fiber is glass is at least 15 wt % fibers, more preferably, at least 20 wt %, and even more preferably, at least 25 wt % fibers, the increasing amount of fibers serving to correspondingly increase the rigidity and dimensional stability of the article eventually to be molded from the particles. Generally, no more than 40 wt % of the particles will be glass fiber.

Other fillers such as aramid fiber have a lower density (g/cc) (note that this refers to the density of the material that the fiber is made of, and is not the bulk density of the fiber in whatever physical form it is being used), about 1.5, than the fluoropolymer (density of about 1.7 to 2.15) and glass (density of about 2.5), with the density of carbon fiber (about 1.85), and PTFE (density 2.15), being nearer to or identical with the fluoropolymer. Under this circumstance of differing densities for the filler fibers, the highly filled condition for all the filler fibers is better expressed as volume % rather than weight %. In this regard, the preferred vol % of filler fiber in the fluoropolymer particles is at least 10 vol %, preferably at least 15 vol %, more preferably at least 18 vol %, and even more preferably at least 22 vol %. Generally no more than 50 vol % of the fluoropolymer particle will be fiber filler. All volume percents are based on the total volume of the fluoropolymer plus fiber filler in the particles.

Preferably the width of the particles, which will be the diameter of the extruded/quench strand, is no greater than about 60 mils (1530 micrometers) and more preferably no greater than about 50 mils (1275 micrometers). The minimum width of the particle will depend on the wt % of fibers present, i.e. a smaller wt % fibers will enable smaller diameter strands to be extruded. Generally, the minimum width will be at least about 25 mils (637 micrometers), preferably at least 40 mils (1020 micrometers) and more preferably at least 45 mils (1147 micrometers, to facilitate the extrusion fabrication of the fiber-filled particles without plugging the extrusion orifice, especially as the loading of fibers in the fluoropolymer is increased. Where there are two width dimensions, e.g. in the case of the oval cross-section particle shown in FIG. 2, the precise width is the average of the two diameters. Particles obtained from a single strand exhibit a variation in diameter arising from the variation in diameter of the molten strand. For example, micrometer measurement of the diameter of thirty particles extruded from a 64 mil (1631 micrometers) diameter orifice reveal a diameter variation of from 45 to 60 mils (1147 to 1520 micrometers).

Preferably the, length of the fiber-filled/melt-fabricable fluoropolymer particles is no greater than about 80 mils (2400 micrometers), and more preferably no greater than about 70 mils (1784 micrometers). In actual operation of chopping up a molten/quenched extruded strand of the fiber-filled/melt-fabricable fluoropolymer composition, the length of the particles is also subject to variation even though the cutter is set for a single length. For example, the above described thirty particles exhibited lengths ranging from 62 to 69 mils (1590 to 1770 micrometers). Preferably, the fiber-filled fluoropolymer particles have a small aspect ratio (ratio of length to width dimensions), which facilitates the feeding of the particles to the molding equipment without interrupting the feed by bridging. Thus, the aspect ratio of the particles is preferably no greater than 2:1, preferably no greater than 1.5:1.

Because of this variation in particle size (width and length), the particle sizes expressed herein apply to at least 80 wt % of the particles, more preferably to at least 90 wt %, and even more preferably to all the particles. The number of particles exceeding the specified particle size can be estimated by comparing the count of specified particle size particles with the count of particles outside the specified size from a sample of at least thirty randomly selected particles, or by classification as described in the next paragraph. The weights of these counted particles can be compared for more precise determination.

The particle size, width and length can be determined by actual measurement, e.g. using a micrometer, or by measurement applied to magnified photographs of particles. The screening (classification) method disclosed in U.S Pat. No. 6,632,902 can also be used for preliminary determination, which can negate the need for direct measurement. In accordance with the screen method, if 80 wt % of a representative sample of a lot of particles pass through a sieve with openings of 70 mils (1784 micrometers) and is retained on a screen with openings of 25 mils (637 micrometers), then 80 wt % of these particles would be in the size range of 637 micrometers to 1784 micrometers). In accordance with this measurement method for determining particle size, it is preferred that at least 80 wt % of the glass-filled/melt-fabricable fluoropolymer particles of the present invention and used in accordance with the present invention are in the size range of 500 to 1800 micrometers, more preferably in the 500 to 1500 micrometer size range.

The fiber-filled/melt-fabricable particles described above are used in molding processes in the same manner as the larger pellets, to obtain improved results arising from increased melt flowability of the molten composition as compared to when the molding is carried out with the larger pellets.

### EXAMPLES

The fluoropolymer used in these Examples is ETFE available from E.I. du Pont de Nemours and Company as TEFZEL® 200 ETFE fluoropolymer, having a melt flow rate of 7 g/10 min, determined at 297° C., and in the form of extrusion melt-formed pellets measuring about 125 mils (3185 micrometers) in diameter and 175 mils (4460 micrometers) in length. The fiber used in the Examples is glass fiber, but any of the other fibers described above could be used to obtain similar results. The glass fiber used is available from the St. Gobain/Vetrotex as grade 910 chopped E-glass fiber strand, the fiber length being about 188 mils (4.5 mm) and the fiber diameter being 10 micrometers. A dry-mixed composition is prepared containing 30 wt % glass fibers and 70 wt % of the ETFE pellets. This composition is feed to a single screw Brabender® mixer operating at 10 rpm and heated to a melt temperature of 585° F. (307° C.), which extrudes the molten composition through a die shown in FIG. 4 and having an orifice diameter of 64 mils (1631 micrometers). The extruded strand is pulled through a water quench bath by nip rolls, which in turn feeds the quenched, solidified strand to a rotating cutter set for chopping up the strand into 62 mil (1590 micrometers) length. The resultant glass fiber-filled particles, when viewed under magnification, reveal the stubs of glass fibers extending only from two cut ends of each particle, indicating the fiber alignment in one direction within the particle. Micrometer measurement of the width and length of these particles reveals that the width varies from 45 to 60 mils (1147 to 1520 micrometers) and the length varies from 62 to 69 mils (1590 to 1770 micrometers).

These particles are fed to an injection molding machine wherein the article to be formed is in the shape of a thin-walled cup having a hole in the bottom and an outwardly extending apron from the top of the cup shape. The diameter of the apron is about 4 mm, the outer diameter of the cup is about 2 mm, the depth of the cup is about the same as its outer diameter, and the wall thickness is about 2.5 mm. The mold is double gated on opposite sides of the apron and multiple molds are simultaneously filled with fluoropolymer/glass fiber composition for each cycle of injection molding. This means that the molten composition has to travel through the runners to each gate of each mold and then into each mold. The injection molding result is that each mold is completely filled, cycle after cycle, with the molten composition to give completely formed thin-walled articles. In addition to this complete filling of each mold, the resultant articles have a substantially uniform wall thickness.

When this injection molding is repeated with pellets of glass-filled ETFE (30 wt % glass fiber) of about the same size as the starting pellets (125 mils (3185 micrometers) in diameter and 175 mils (4460 micrometers) in length) obtained by Brabender processing and melt extrusion of the dry mixture of ETFE pellets with the glass fibers and through a 125 mil (3185 micrometers) diameter extrusion die of the design of FIG. 3, the result is incomplete filling of the mold. When the Brabender extruded glass-filled pellets are ground to a slightly smaller size, the injection molding result is about the same, but with the added disadvantage that the portions of the pellets that are ground away represent waste and a contaminant of the ground pellets fed to the injection molding machine. These larger glass-filled fluoropolymer pellets have the additional disadvantage of causing excessive wear on the barrel and screw of the injection molding machine as compared to use of the glass-filled fluoropolymer particles in accordance with the present invention.

The better melt flowability of the glass-filled fluoropolymer particles used in accordance with the present invention not only provides better injection molded articles, but enables the number of articles to be molded per cycle of injection molding operation to be increased. Thus, for articles that can be molded using the larger-size glass-filled fluoropolymer pellets, use of the glass-filled fluoropolymer particles in accordance with the present invention enables a greater number of molds to be filled per cycle, thereby improving productivity of the injection molding operation. Similar results are obtained when such fibers as aramid fiber, carbon fiber, or PTFE fiber are substituted for the glass fiber.

What is claimed is:

1. In the process of molding a molten composition comprising fiber and melt-fabricable fluoropolymer to form said composition into an article, wherein the presence of said fiber in said composition decreases the melt flowability of said composition as compared to the melt flowability of said melt-fabricable fluoropolymer by itself, the improvement comprising carrying out said molding on said composition obtained from melting melt-formed particles of said composition, at least 80 wt % of said particles having a width no greater than about 70 mils (1784 micrometers), thereby minimizing any decrease in melt flow of said composition.

2. Process comprising molding a molten composition comprising fiber and melt-fabricable fluoropolymer to form an article, said molten composition being obtained by melting melt-formed particles of said composition, said particles having a width of no greater than about 70 mils (1784 micrometers).

3. Process of claim 2 wherein said molding is by injection molding.

4. Process of claim 2 wherein said particles are obtained by extruding said composition into a strand, aligning said fibers in the direction of said extruding during said extruding, and chopping up said strand.

5. Process of claim 2 wherein at least 80 wt % of said particles have a width of no greater than about 60 mils (1530 micrometers).

6. Process of claim 2 wherein at least 80 wt % of said particles have a length of no greater than about 80 mils (2400 micrometers).

7. Process of claim 1 wherein said fiber is organic fiber or inorganic fiber.

8. Process of claim 7 wherein said fiber is glass fiber, aramid fiber, PTFE fiber, or carbon fiber.

9. Melt-formed particles of composition comprising fibers and melt-fabricable fluoropolymer, said fibers constituting at least about 10 vol % of the total weight of said fibers and said melt-fabricable fluoropolymer, at least about 80 wt % of said particles having a width no greater than about 70 mils (1784 micrometers) and length no greater than about 80 mils (2400 micrometers).

10. The melt-formed particles of claim 9 wherein said fibers are glass and constitute at least about 15 wt % of said total weight.

11. The melt-formed particles of claim 9 wherein up to about 40 wt % of said fibers is present.

12. The melt-formed particles of claim 9 wherein said fibers are aligned in one direction.

13. The melt-formed particles of claim 9 wherein said fiber is organic fiber or inorganic fiber.

14. The melt-formed particles of claim 13 wherein said fiber is aramid fiber, PTFE fiber, or carbon fiber.

15. The melt-formed particles of claim 13 wherein said fiber is glass fiber.

16. The melt-formed particles of claim 15 wherein said glass fiber is free of coupling agent.

17. The melt-formed particles of claim 9 having an aspect ratio of no greater than 2:1.
